(19) United States
(12) Patent Application Publication
(10) Pub. No.: US 2017/0028535 A1
(43) Pub. Date: Feb. 2, 2017

(54) Multipurpose Wrench Tool

(71) Applicant: Antonio Frandina, Garden City, NY (US)

(72) Inventor: Antonio Frandina, Garden City, NY (US)

(21) Appl. No.: 15/223,670

(22) Filed: Jul. 29, 2016

Related U.S. Application Data
(60) Provisional application No. 62/198,560, filed on Jul. 29, 2015.

(51) Int. Cl. B25B 13/06; B25B 21/00; B25B 23/00; B25B 13/50

(52) U.S. Cl. CPC B25B 13/06; B25B 13/5091; B25B 21/007; B25B 23/0035

(57) ABSTRACT

A tubular body has a first socket end that allows for engagement with nuts by means of a first lateral surface, facilitating loosening and tightening of the nuts. Notches can be positioned along the lateral surface to grip the wings of wingnuts. The first socket end can further be tapered to better interface with wingnuts. A second end may be a second socket end or a drive end, allowing for better compatibility or allowing for powered drills to be coupled to the tubular body. To engage such a drill with the drive end, a drill adapter is provided for insertion into the drive end. Further, an guide-receiving channel can be formed through the tubular body to allow for guide accessories, such as chains, to be used to help with aligning the tubular body with a faucet and corresponding nut. Different sizes can be provided to accommodate more cramped work areas.

The current application claims a priority to the U.S. Provisional Patent application Ser. No. 62/198,560 filed on Jul. 29, 2015.

### FIELD OF THE INVENTION

The present invention relates generally to a tool for tightening or loosening fasteners, for example nuts. The present invention is well suited for use in a variety of applications, an example of which is plumbing.

### BACKGROUND OF THE INVENTION

Plumbing is a well-established trade that already consists of numerous tools that are typically used to assist in the installation and maintenance of the plumbing system. Some of the most commonly utilized components of the plumbing system include sinks and toilets, and it is these components of the system that are most susceptible to failure due to constant usage. Installing and maintaining these components requires the adjustment of nuts, wingnuts, and similar fasteners. Such adjustments are often a hassle, requiring up a significant amount of time and effort. The present invention is a tool that seeks to facilitate the removal of such fasteners through a multipurpose solution.

The installation and maintenance of these components can be a hassle even with existing tools that are supposed to make the task easier. The present invention is a wrench that can make these tasks even easier to complete.

### BRIEF DESCRIPTION OF THE DRAWINGS

FIG. 1 is a perspective view of a core embodiment of the present invention.

FIG. 2 is a front view of the core embodiment of the present invention.

FIG. 3 is a top view of the core embodiment of the present invention.

FIG. 4 is a perspective view showing a first socket end and a second socket end for a first possible embodiment of the present invention.

FIG. 5 is a perspective view showing a cylindrical shaped tubular body for a second possible embodiment of the present invention.

FIG. 6 is a bottom perspective view showing a drive end in combination with a cylindrical tubular body for the second possible embodiment of the present invention.

FIG. 7 is a bottom view showing the drive end for the second possible embodiment of the present invention.

FIG. 8 is a perspective view showing a potential drill adapter used with the second possible embodiment of the present invention.

FIG. 9 is a bottom perspective view showing the potential drill adapter inserted into the drive end of the second possible embodiment of the present invention.

FIG. 10 is a bottom perspective view showing a hexagonal shaped tubular body combined with the drive end for a third possible embodiment of the present invention.

FIG. 11 is a bottom view showing the hexagonal shaped tubular body combined with the drive end for a third possible embodiment of the present invention.

FIG. 12 is a perspective view showing how an alignment accessory tool can be used in combination with the present invention.

### DETAIL DESCRIPTIONS OF THE INVENTION

All illustrations of the drawings are for the purpose of describing selected versions of the present invention and are not intended to limit the scope of the present invention.

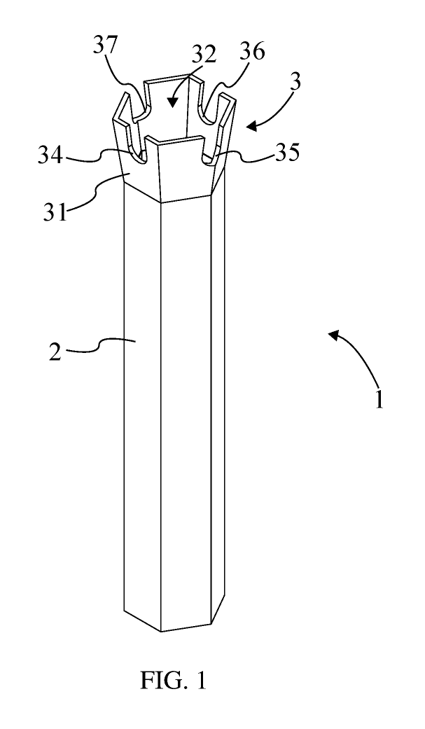

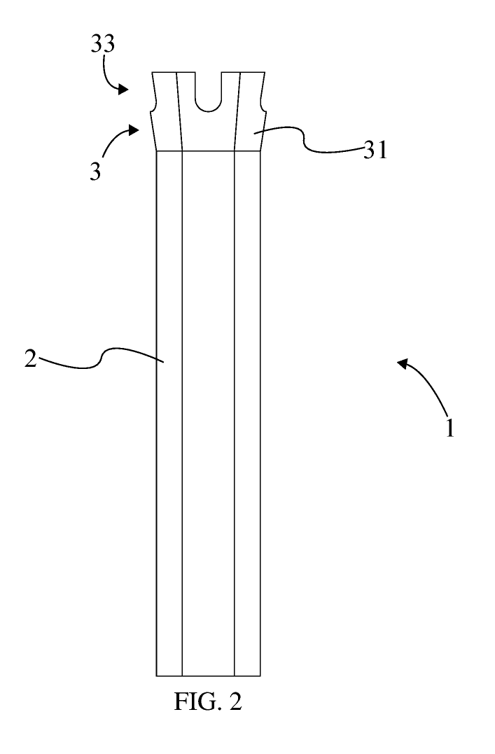

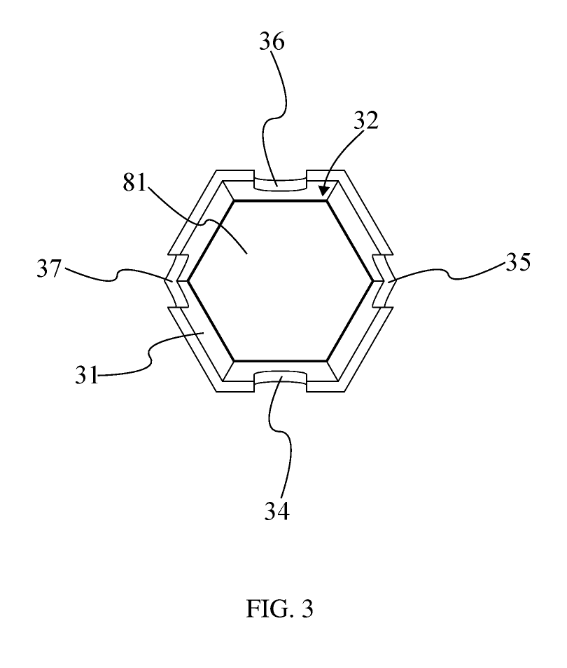

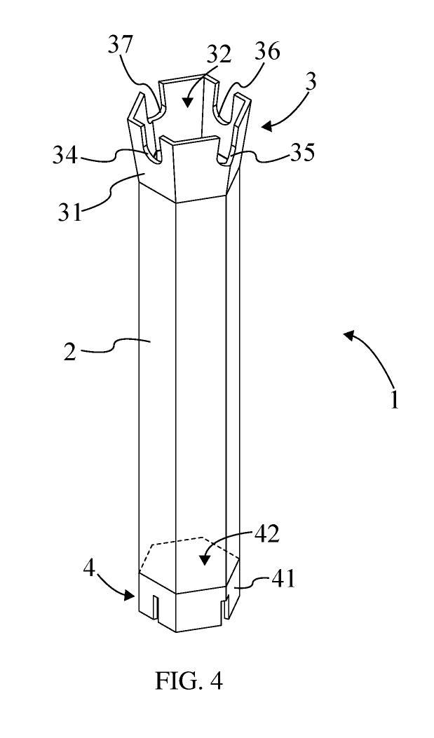

The present invention is a multipurpose wrench that is especially beneficial for plumbing applications, allowing for various plumbing fixtures (e.g. wing nuts and lock nuts) to easily be loosened or tightened. A plumber can thus work more efficiently when dealing with basin sinks, toilets, and other plumbing fixtures. The present invention is initially described in a core embodiment, followed by several potential alternative embodiments. The core embodiment is illustrated via FIG. 1-FIG. 3 while additional embodiments and components are depicted via FIG. 4-FIG. 12.

In the core embodiment, the present invention comprises a tubular body 1, which itself comprises an elongated segment 2 and a first socket end 3. The tubular body 1 is easily manipulated by a person and the first socket end 2 is adapted to interface with a nut. A user can thus use the first socket end 2 of the tubular body 1 to tighten or loosen a nut. The first socket end 1 comprises a first lateral surface 31, a first fastener-receiving region 32, and a plurality of notches 33. The first lateral surface 31 is perimetrically connected to the elongated segment 2. Thus, the first lateral surface 31 forms a continuous entity in combination with the elongated segment 2. The first fastener-receiving region 32 is positioned within the first lateral surface 31. The volume bounded by the first lateral surface 31 effectively forms the first fastener-receiving region 32. The plurality of notches 33 traverses into the first lateral surface 31, at a free edge of said first lateral surface 31. More specifically, the plurality of notches 33 is positioned at an end of the first lateral surface 31 which is opposite the elongated segment 2. Describing the plurality of notches 33 in more detail, the plurality of notches 33 is peripherally and evenly distributed around the first lateral surface 31.

The core embodiment, as described above, allows the present invention to be used to interface with various types of fasteners, including nuts with and without wings. The first fastener-receiving region 32 is able to fit about a nut or the head of a screw; the tubular body 1 can then be rotated in order to tighten or loosen an engaged fastener. The plurality of notches 33 facilitates engagement with wingnuts, as each notch is able to receive an individual wing of a wingnut. The plurality of notches 33 thus increases the versatility of the present invention; the present invention is equally suited to fasteners with wings and fasteners without wings.

In one embodiment of the present invention, as illustrated in FIG. 1-FIG. 4, the plurality of notches 33 comprises a first notch 34, a second notch 35, a third notch 36, and a fourth notch 37. Four notches allows for engagement with wingnuts (or similar fasteners) that have up to four wings. In other embodiments a greater or lesser number of notches 33 could be utilized; however, since wingnuts commonly have two or four wings, four notches is an ideal amount for general compatibility.

Preferably, each of the four notches is evenly spaced from one another, matching a common configuration of wings on wingnuts. Thus, the first notch 34 and the third notch 36 are positioned opposite each other about the first socket end 3. Similarly, the second notch 35 and the fourth notch 37 are positioned opposite each other about the first socket end 3. Effectively, each of the plurality of notches 33 are sequentially positioned around the first lateral surface 31 of the first socket end 3, with the second notch 35 being positioned between the first notch 34 and the third notch 36. Likewise, the fourth notch 37 is positioned between the third notch 36 and the first notch 34. This configuration enables the present invention to be utilized in conjunction with wingnuts alongside other types of fasteners.

In one embodiment, in order to better interface with wingnuts, the first lateral surface 31 is tapered towards the elongated segment 2. Thus, the perimeter of the first lateral surface 31 narrows as it approaches the elongated segment 2. This tapered shape allows for the first fastener-receiving region 32 to receive a main fastener body (e.g. a nut or the head of a screw or bolt), while the plurality of notches 33 is able to engage peripheral fastener elements (e.g. the wings of a wingnut). An embodiment with the plurality of notches and this tapered first lateral surface is suited for being used with removing or installing faucets into a sink. The tapered first lateral surface 31 and the plurality of notches 33 allow for a wingnut to easily be removed from the faucet. The first fastener-receiving region 32 is then able to engage and loosen a nut which connects the faucet to the sink, allowing the faucet to be removed and replaced. Conversely, this embodiment can be used to tighten a fastening nut and wingnut in order to install a faucet into a sink.

The profile of the present invention can be adapted for different embodiments. For example, in one embodiment the tubular body 1 has a cross-section with a polygonal shape 71. In the illustrated figures (FIG. 1-FIG. 4), this is shown as being a hexagonal cross-section which allows for the present invention to be utilized with any fastener that has a hexagonal shape. Of course, the present invention could be adapted for use with square-shaped, triangular-shaped, or other polygonal-shaped 71 fasteners as well.

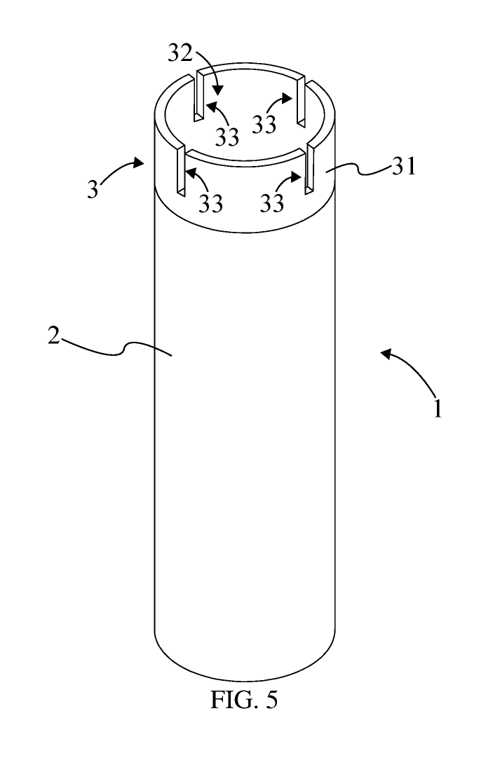

Alternatively, in another embodiment the tubular body 1 has an cross-section with an elliptical shape 72, as shown in FIG. 5-FIG. 7. This allows for engagement with fasteners that have a rounded profile. This embodiment, in comparison to one with a polygonal shape 71, is better suitable for use with fasteners typically used in certain applications. A non-limiting example of such is the circular lock nuts often used with toilets.

In another embodiment, the tubular body further comprises a second socket end 4. This second sock end 4 is placed at a bottom of the elongated segment 2, with the first socket end 3 and the second end 4 being positioned opposite each other along the elongated segment 2. The second socket end 4 is configured to engage with a fastener, similar to the first socket end 3. Thus, the second socket end 4 comprises a second lateral surface 41 and a second fastener-receiving region 42. The second lateral surface 41 is perimetrically connected to the elongated segment 2, forming a unitary body. This relation parallels the connection between the first lateral surface 31 and the elongated segment 2. The second lateral surface 41 is also aligned with the elongated segment 2, such that the second lateral surface 41 is coincident with the elongated segment 2. Effectively, the elongated segment 2 and the second lateral surface 41 combine to form part of a uniform tubular body 1. This orientation differs from one embodiment of the first lateral surface 31, which is described as being tapered towards the elongated segment 2.

Resultantly, the second socket end 4 is configured to adapt a fastener in the same manner as the first socket end 3. The second socket end 4 is suitable for interfacing with fasteners that do not have flared edges, as shown in FIG. 4. The second socket end is thus suited for applications including toilet fasteners, similar to the rounded lock nuts often used with toilets. Said fasteners are engaged via the second fastener-receiving region 42 which is positioned within the second lateral surface 41. Effectively, the volume of the second fastener-receiving region 42 is bounded by the second lateral surface 41.

In an embodiment that comprises both the first socket end 3 and the second socket end 4, the present invention can be used for different types of fasteners. For example, the first socket end 3, with a tapered first lateral surface 31, could be used for wingnuts. Conversely, the second socket end 4, with a straight edge, could be used for hex screws or other fasteners with a geometric profile. Similarly, different shapes could be provided for the first socket end 3 and the second end 4 (e.g. one could be square and the other hexagonal) to allow for interfacing with a greater variety of fasteners. The illustrated figures show a hexagonal profile or an elliptical profile as those are among the most common found in plumbing applications. Of course, in further embodiments other shapes for the socket ends can be utilized while remaining within the scope of the present invention. An illustration of this embodiment is provided via FIG. 4.

Potentially, secondary notches could be positioned into the second lateral surface 41, allowing the second socket end 4 to be used to engage wingnuts in addition to other fastener types. A plurality of secondary notches, in this potential embodiment, is positioned around the lower edge of the second lateral surface 41. As with the plurality of notches 33 of the first socket end 31, the secondary notches create slots that receive the corresponding wings of wingnuts. As wingnuts are typically produced with two or four wings, it is preferable to provide at least two or four secondary notches. The present invention does not seek to limit the specific number of secondary notches however, and in embodiments that comprise the secondary notches, any number of secondary notches may be utilized.

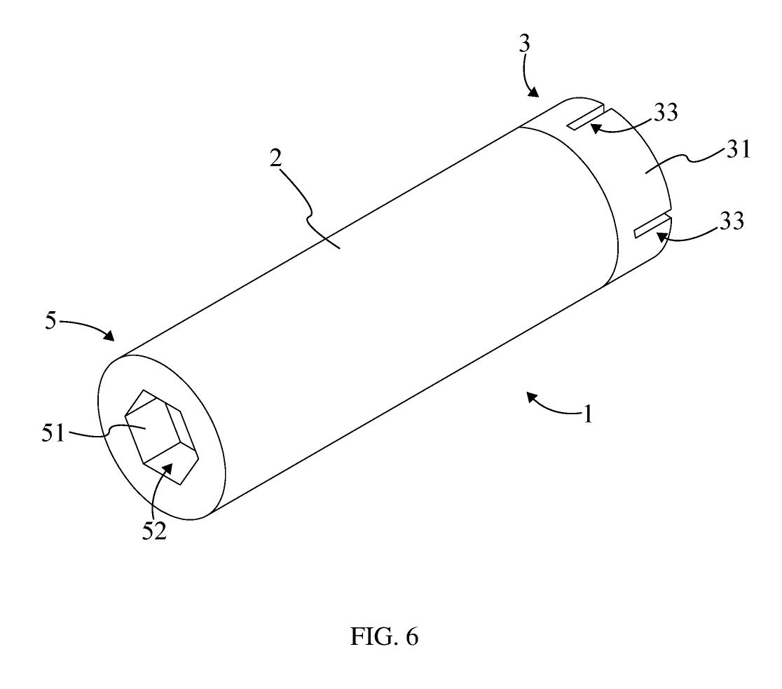

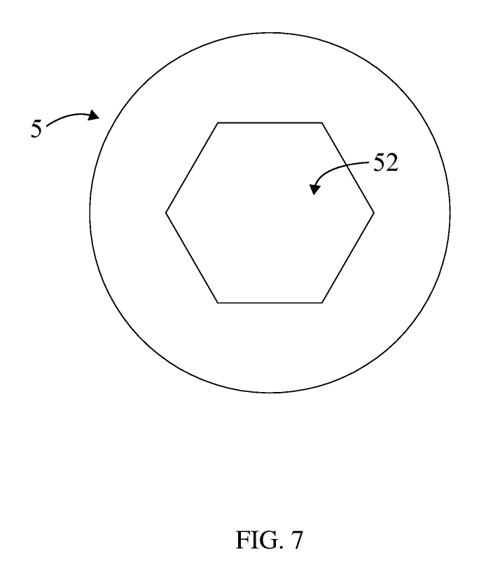

In another embodiment of the present invention, the tubular body 1 further comprises a drive end 5. The drive end 5 allows for the tubular body 1 to engage with a drill adapter 6 of the present invention. These two components allow for use of powered drills to drive rotation of the present invention. The ability to use a powered drill results in the present invention being more efficient and user-friendly. FIG. 6 and FIG. 7 serve to illustrate the drive end 5.

The first socket end 3 and the drive end 5 are positioned opposite each other along the elongated segment 2, which allows a drill to engage the present invention at one end (the drive end 5) and a fastener to be engaged by the present invention at the other end (the first socket end 3). In order to fit the drill adapter 6, the drive end 5 comprises an adapter lateral surface 51 and an adapter-receiving socket 52. This adapter lateral surface 51 parallels the second lateral surface 41 of the embodiment with a second socket end 4; the adapter lateral surface 51 is perimetrically connected to the elongated segment 2. Thus the adapter lateral surface 51 forms a unitary body with the elongated segment 2. The adapter-receiving socket 52 is positioned within the adapter lateral surface 51. The adapter-receiving socket 52 is effectively a cavity in the tubular body 1 that fits the drill adapter 6, allowing a drill to interface with the present invention. The drill adapter 6 is correspondingly positioned into the adapter-receiving socket 52, such that a drill is torsionally coupled with the drive end 5 through the drill adapter 6. The drill can thus be used to drive rotation of a fastener engaged by the first socket end 3, allowing for a fastener to easily be loosened or tightened as desired by a user.

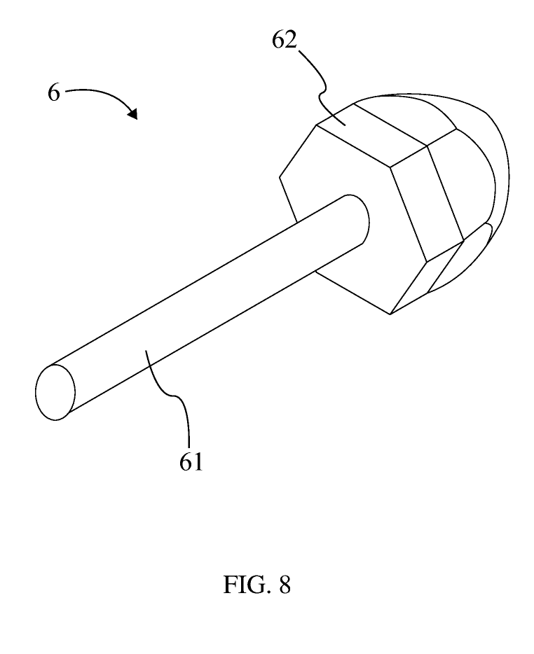

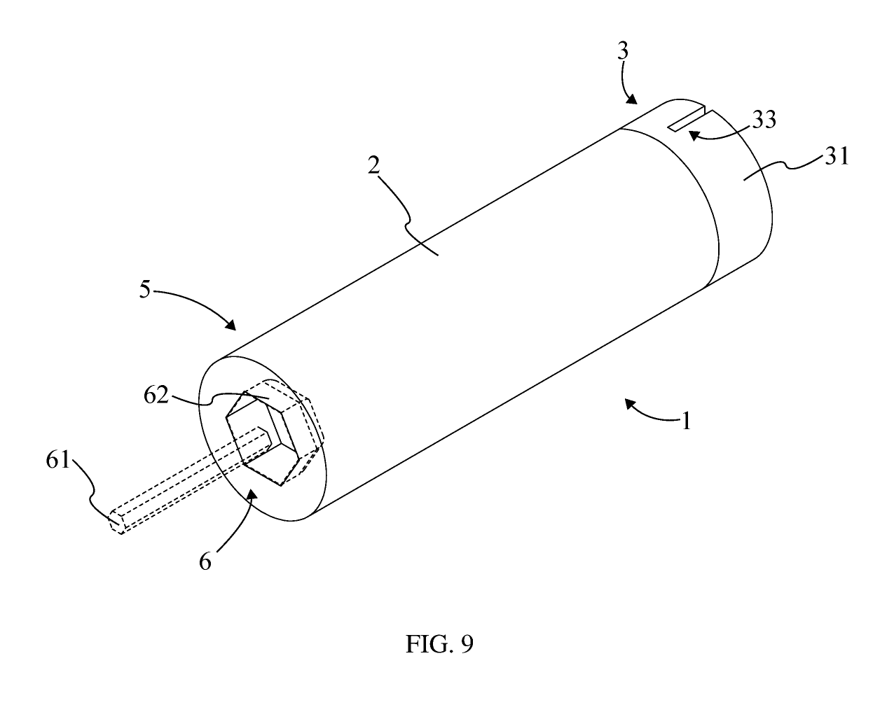

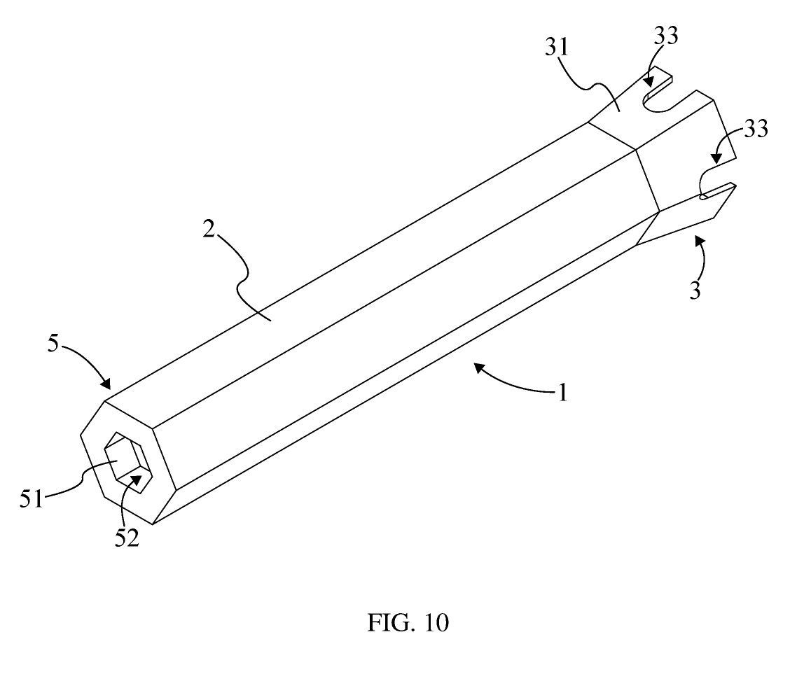

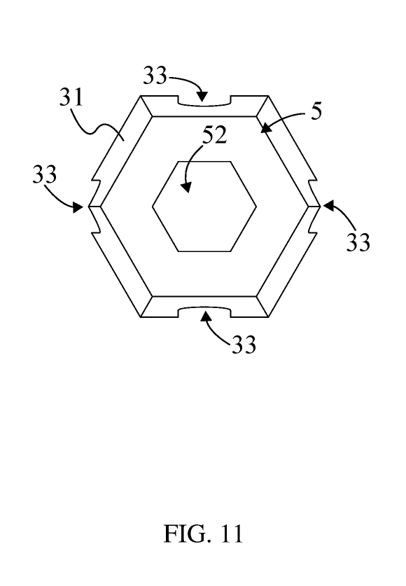

The drill adapter 6 itself comprises a shank 61 and an adapter head 62. The adapter head 62 is the portion that inserts into the adapter-receiving socket 52, while the shank 61 allows the drill adapter 6 to be coupled with a drill. The adapter head 62 is adjacently connected to the shank 61, such that rotation of the shank 61 results in corresponding rotation of the adapter head 62 and, ultimately, the tubular body 1. The adapter head 62 itself is flushly positioned within the adapter-receiving socket 52. A flush fit between the adapter head 62 and the adapter-receiving socket 52 is desirable as it prevents vibrations when the drill is operated. The vibrations, if unchecked, could otherwise result in damage to the present invention, plumbing fixtures, or even persons. The drill adapter 6 is shown in FIG. 8, while the engagement between the drill adapter 6 and drive end 5 is shown in FIG. 9. The drive end 5 can also be integrated with other embodiments, as shown in FIG. 10 and FIG. 11.

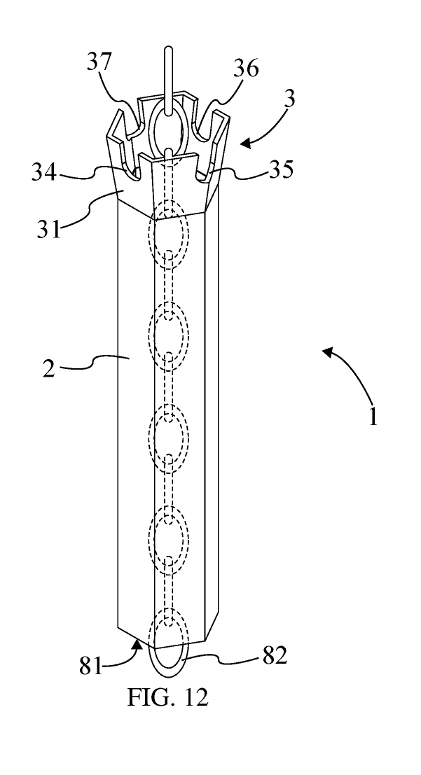

To assist with alignment of the tubular body 1 with fasteners, in one embodiment the present invention comprises a guide-receiving channel 81. The guide-receiving channel 81 laterally traverses into the tubular body 1, forming a tunnel that travels through and along the tubular body 1. This tunnel is able to receive an alignment accessory 82, for example a chain as shown in FIG. 12. The ability to use an alignment accessory 82 is beneficial for when the present invention is used in cramped environments, for example the installation of faucets into a sink. A chain with a stop can be suspended from a faucet connection, allowing the chain to be used as a guide for easily aligning the tubular body 1 with said faucet connection.

The various embodiments of the present invention described are not intended; further embodiments remain possible within the scope of the present invention. For example, the above embodiments could be combined to create more specific implementations of the present invention. The present invention can thus be adapted for specific use with toilet valve fixtures, plastic lock nuts, and faucet connections.

An embodiment adapted for use with faucet connections includes the core embodiment (with elongated segment 2 and first socket end 3), four notches for the plurality of notches 33, polygonal cross-section 71, and the guide-receiving channel 81. This embodiment, shown in FIG. 1-FIG. 3 and FIG. 12, is suited for use with faucet connections such as found in basin sinks. The first socket end 3 allows for wing nuts to easily be loosened or tightened while the guide-receiving channel 81 enables a chain to be used to align the tubular body 1 with a faucet connection. For this application, an example length of the tubular body 1 is 11½ inches, which is compact enough to be used for sink applications while providing sufficient clearance to allow a user's hands to operate the present invention within the plumbing area of a sink. In another embodiment, adapted for toilet valve fixtures, the length of the tubular body 1 is 6 inches. This reduced length (compared to an embodiment adapted for sinks) is more maneuverable within the tighter confines of toilet plumbing.

In another embodiment, an elliptical cross-section 72, plurality of notches 33, drive end 5, and drill adapter 6 are combined with the core embodiment to provide a plastic lock nut tool. An ideal length for the tubular body 1 in this embodiment is 6 inches, which is small enough to be maneuverable within the confines of plumbing fixtures while still being large enough to be ergonomically handled by a person. Further, the plastic lock nut tool allows for a drill to be used to loosen a lock nut, thanks to the drive end 5 and drill adapter 6. The resulting configuration of components is well suited for use with lock nuts. This embodiment is shown in FIG. 5-FIG. 7.

While material and dimensions are referenced above, it is understood that the different materials and dimensions may be used without departing from the scope of the present invention. Likewise, several variant embodiments (including combinations of embodiments) remain possible within the scope of the present invention. Ultimately, the present invention provides an efficient and convenient tool which is well suited plumbing or ultimately any application that requires manipulation of fasteners.

Example uses of the present invention include unlocking nuts on hot water lines and cold water lines, unlocking plastic wing nuts from faucets, and changing toilet fill valves. These and earlier examples referring specifically to plumbing applications are not meant to limit the present invention for use in such applications; the present invention may ultimately be utilized in any manner as desired by a user.

Although the invention has been explained in relation to its preferred embodiment, it is to be understood that many other possible modifications and variations can be made without departing from the spirit and scope of the invention as hereinafter claimed.

What is claimed is:

1. A multipurpose wrench tool comprises:
a tubular body;
the tubular body comprises an elongated segment and a first socket end;
the first socket end comprises a first lateral surface, a first fastener-receiving region, and a plurality of notches;
the first lateral surface being perimetrically connected to the elongated segment;
the first fastener-receiving region being positioned within the first lateral surface;
the plurality of notches traversing into the first lateral surface;
the plurality of notches being positioned opposite the elongated segment along the first lateral surface; and
the plurality of notches being peripherally and evenly distributed around the first lateral surface.

2. The multipurpose wrench tool as claimed in claim 1 comprises:
the plurality of notches comprises a first notch, a second notch, a third notch, and a fourth notch;
the first notch and the third notch being positioned opposite each other about the first socket end;
the second notch and the fourth notch being positioned opposite each other about the first socket end;
the second notch being positioned between the first notch and the third notch; and
the fourth notch being positioned between the third notch and the fourth notch.

3. The multipurpose wrench tool as claimed in claim 1 comprises:
the first lateral surface being tapered towards the elongated segment.

4. The multipurpose wrench tool as claimed in claim 1 comprises, wherein a cross-section of the tubular body is a polygonal shape.

5. The multipurpose wrench tool as claimed in claim 1, wherein a cross-section of the tubular body is an elliptical shape.

6. The multipurpose wrench tool as claimed in claim 1 comprises:
the tubular body further comprises a second socket end;
the first socket end and the second socket end being positioned opposite each other along the elongated segment;
the second socket end comprises a second lateral surface and a second fastener-receiving region;
the second lateral surface being perimetrically connected to the elongated segment; and
the second fastener-receiving region being positioned within the second lateral surface.

7. The multipurpose wrench tool as claimed in claim 1 comprises:
a drill adapter;
the tubular body further comprises a drive end;
the first socket end and the drive end being positioned opposite each other along the elongated segment;
the drive end comprises an adapter lateral surface and an adapter-receiving socket;
the adapter lateral surface being perimetrically connected to the elongated segment;
the adapter-receiving socket being positioned within the adapter lateral surface; and
the drill adapter being positioned into the adapter-receiving socket, wherein a drill is torsionally coupled with the drive end through the drill adapter.

8. The multipurpose wrench tool as claimed in claim 7 comprises:
the drill adapter comprises a shank and an adapter head;
the adapter head being adjacently connected to the shank; and
the adapter head being positioned flush within the adapter-receiving socket.

9. The multipurpose wrench tool as claimed in claim 1 comprises:
a guide-receiving channel;
the guide-receiving channel laterally traversing into the tubular body; and
the guide-receiving channel traversing through and along the tubular body.
